(19) United States
(12) Patent Application Publication
(10) Pub. No.: US 2025/0231566 A1
(43) Pub. Date: Jul. 17, 2025

(54) SUN GLARE AVOIDANCE SYSTEM (SAS) IN SEMI OR FULLY AUTONOMOUS VEHICLES

(71) Applicant: FLORIDA ATLANTIC UNIVERSITY BOARD OF TRUSTEES, Boca Raton, FL (US)

(72) Inventors: Mehrdad Nojoumian, Boca Raton, FL (US); Lars Skaug, Boca Raton, FL (US)

(21) Appl. No.: 19/016,240

(22) Filed: Jan. 10, 2025

Related U.S. Application Data
(60) Provisional application No. 63/620,352, filed on Jan. 12, 2024.

(51) Int. Cl. G05D 1/606; G05D 1/69; G05D 111/10; G05D 111/30; G06V 10/60

(52) U.S. Cl. CPC G05D 1/606; G05D 1/69; G06V 10/60; G05D 2111/10; G05D 2111/30

(57) ABSTRACT

Systems, methods, and devices that can be used to augment and address various deficiencies such as vision system impairment in autonomous robotic systems are described herein. A system may include at least one sensing device that is used to monitor data and trigger corrective operations in response to detected low visibility or obstructed conditions such as a sun glare condition.

### CROSS-REFERENCE TO RELATED APPLICATIONS

This application claims priority to and the benefit of U.S. Provisional Application No. 63/620,352, titled “SUN GLARE AVOIDANCE SYSTEM (SAS) IN SEMI OR FULLY AUTONOMOUS VEHICLES,” filed on Jan. 12, 2024, the content of which is hereby incorporated by reference herein in its entirety.

### BACKGROUND

There is increasing demand and adoption of autonomous robotic systems (e.g., autonomous vehicles, surgical robots, care-giving robots, and the like) and vision systems. However, many existing systems are plagued by technical challenges and limitations. For example, it is expensive and technically complex to develop and deploy autonomous vehicle technology and there are regulatory challenges in operating such systems. Additionally, there are various concerns regarding the safety of operating autonomous vehicles on public roads and a lack of standardization in such technologies.

One of the major challenges that semi or fully autonomous vehicles (AVs or self-driving cars) face is when their vision system is partially blinded due to sun glare or other types of visual obstructions. The vision system is one of the major sensory solutions of AVs for perceiving the environment. The inability to recognize lane lines in auto steering systems and obstacles/road infrastructure in order to implement emergency braking systems can potentially be the root cause of catastrophic accidents. Several approaches are being investigated for improving the performance of sensors in bright conditions. However, these methods generally require overhaul or replacement of existing sensors at high costs to address issues including sun glare.

As such, there is a need for improved safety and reliability of such systems. These needs and others are at least partially satisfied by the present disclosure.

### SUMMARY

Disclosed herein are systems, methods, and devices that can be used to augment and address various deficiencies such as vision system impairment in autonomous robotic systems. In some examples, the systems described herein address many deficiencies and reduce costs by working synergistically with existing sensors through system integration and control.

Embodiments of the present disclosure provide a Sun glare Avoidance System (SAS) for semi or fully autonomous vehicles using the existing AV hardware, including but not limited to, cameras and computing devices, as well as the necessary hardware to, for example, change the position of the camera periodically. As explained in more detail herein, in some implementations, the system will first determine if sun glare exists, and consequently, it will provide a counter solution to make sure the vision system remains fully functional. In the determination phase, pre-stored data (including but not limited to longitude, latitude, time of the day, direction, and weather conditions) can be used to define the existence of the sun glare. In other examples, partial samples are periodically taken from image data (e.g., video frames) to be analyzed for the existence of the sun glare. In the second phase, for the counter solution, the following mechanisms can be utilized, including but not limited to: the camera position is slightly changed while maintaining a sufficient view, lenses are shaded, if possible, a polarizing filter is used, a software solution is executed to reduce the impact of the sun glare, or combinations thereof. These operations can be improved by using machine learning and artificial intelligence techniques over time. Finally, the system can share the existence of sun glare and the results of counter solutions with other vehicles in a connected or cooperative driving context.

In some implementations, a system (e.g., robotic system, self-driving car) is provided. The system can include: at least one sensing device (optical device, image sensor, camera, Light Detection and Ranging (LiDAR)); a processor in electronic communication with the at least one sensing device; and a memory having instructions thereon, wherein the instructions when executed by the processor, cause the processor to: monitor data (e.g., image data, video stream) via the at least one sensing device; and in response to detecting a low visibility or obstructed condition, trigger a corrective operation in relation to the at least one sensing device.

In some implementations, the instructions when executed by the processor cause the processor to further: determine a confidence measure in relation to the detected low visibility or obstructed condition; and trigger the corrective operation in an instance in which the confidence measure satisfies a predetermined threshold.

In some implementations, the confidence measure is determined based at least in part on data (e.g., vehicle data) obtained from one or more other apparatuses or computing devices (e.g., vehicles, robots, databases, or the like).

In some implementations, the instructions when executed by the processor cause the processor to further: transmit an indication of the low visibility or obstructed condition to another apparatus (e.g., another self-driving car) that is within a predetermined range of the at least one sensing device or to a central server.

In some implementations, the low visibility or obstructed condition is determined based at least in part on at least one of: (a) direct analysis of image data (e.g., identifying one or more images that are washed out due to excessive light), (b) a predictive output based at least in part on a direction of travel, time of day, or weather condition, and (c) detected deviation from an object-permanence model.

In some implementations, direct analysis of the image data includes periodically sampling one or more frames of the image data.

In some implementations, the low visibility or obstructed condition is detected based at least in part on a measure of brightness or contrast (e.g., glare, sun glare, blur, obstruction) with respect to one or more frames of the image data that meets or exceeds a predetermined threshold.

In some implementations, the low visibility or obstructed condition is determined based at least in part on real-time or historical visibility information/data corresponding with a geographic location of the at least one sensing device.

In some implementations, the real-time or historical visibility information/data includes at least one of longitude, latitude, time of day, direction, and weather conditions.

In some implementations, triggering the corrective operation includes at least one of: adjusting one or more image processing parameters of image processing software utilized by the system/processor, modifying an operational parameter of the at least one sensing device (e.g., lens position or orientation), and applying a polarizing filter.

In some implementations, the data is utilized for machine vision operations.

In some implementations, the techniques described herein relate to a system, wherein triggering the corrective operation includes changing a position or angle of incidence of the at least one sensing device.

In some implementations, the instructions when executed by the processor cause the processor to further: detect the low visibility or obstructed condition and/or determine an appropriate corrective operation based at least in part on the low visibility or obstructed condition using a machine learning model.

In some implementations, the machine learning model is a neural network model.

In some implementations, the machine learning model is configured to determine object permanence with respect to objects in the data.

In some implementations, the system is embodied as a fully autonomous vehicle, a semi-autonomous vehicle, surgical robot, or care-giving robot.

In some implementations, the system includes a machine vision system.

In some implementations, a cooperative driving system is provided. The cooperative driving system can include: a plurality of vehicles in electronic communication with one another, each vehicle including: at least one sensing device; a processor in electronic communication with the at least one sensing device; and a memory having instructions thereon, wherein the instructions when executed by the processor, cause the processor to: monitor data (e.g., image data, video stream) via the at least one sensing device; and in response to detecting a low visibility or obstructed condition, trigger a corrective operation in relation to the at least one sensing device, wherein each of the plurality of vehicles is configured to transmit an indication of detected low visibility or obstructed conditions to at least another vehicle and/or trigger corrective operations in relation to the at least another vehicle.

In some implementations, each of the plurality of vehicles is configured to transmit the indication of detected low visibility or obstructed conditions to at least another vehicle and/or trigger corrective operations in relation to the at least another vehicle when it is within a predetermined range.

In some implementations, each vehicle is an autonomous or semi-autonomous vehicle.

In some implementations, a cooperative robotic system is provided. The cooperative robotic system can include: a plurality of robots in electronic communication with one another, each robot including: at least one sensing device; a processor in electronic communication with the at least one sensing device; and a memory having instructions thereon, wherein the instructions when executed by the processor, cause the processor to: monitor data (e.g., image data, video stream) via the at least one sensing device; in response to detecting a low visibility or obstructed condition, trigger a corrective operation in relation to the at least one sensing device; and transmit an indication of the detected low visibility or obstructed condition to at least another robot.

In some implementations, a computer-implemented method for identifying and correcting low visibility or obstructed conditions (e.g., sun glare) is provided. The computer-implemented method can include: monitoring data (e.g., image data, video stream) via at least one sensing device; in response to detecting a low visibility or obstructed condition, triggering a corrective operation in relation to the at least one sensing device.

In some implementations, a non-transitory computer readable medium is provided. The non-transitory computer readable medium can include a memory having instructions stored thereon to perform any of the systems or methods described herein.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF DRAWINGS

The components in the drawings are not necessarily to scale relative to each other. Like reference, numerals designate corresponding parts throughout the several views.

FIG. 1 is an example system in accordance with certain embodiments of the present disclosure.

FIG. 2 is flowchart diagram illustrating a method in accordance with certain embodiments of the present disclosure.

FIG. 3 is an example system in accordance with certain embodiments of the present disclosure.

FIG. 4 is an example computing device.

### DETAILED DESCRIPTION

It is appreciated that certain features of the disclosure, which are, for clarity, described in the context of separate embodiments, can also be provided in combination with a single embodiment. Conversely, various features of the disclosure, which are, for brevity, described in the context of a single embodiment, can also be provided separately or in any suitable subcombination. Unless defined otherwise, all technical and scientific terms used herein have the same meaning as commonly understood by one of ordinary skill in the art. Methods and materials similar or equivalent to those described herein can be used in the practice or testing of the present disclosure.

### Definitions

In this specification and in the claims that follow, reference will be made to a number of terms, which shall be defined to have the following meanings:

Throughout the description and claims of this specification, the word “comprise” and other forms of the word, such as “comprising” and “comprises,” means including but not limited to, and are not intended to exclude, for example, other additives, segments, integers, or steps. Furthermore, it is to be understood that the terms comprise, comprising, and comprises as they relate to various embodiments, elements, and features of the disclosure also include the more limited embodiments of “consisting essentially of” and “consisting of.”

As used herein, the singular forms “a,” “an,” and “the” include plural referents unless the context clearly dictates otherwise. Thus, for example, reference to a “sensing device” includes embodiments having two or more such sensing device unless the context clearly indicates otherwise.

Ranges can be expressed herein as from “about” one particular value and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It should be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

For the terms “for example” and “such as,” and grammatical equivalences thereof, the phrase “and without limitation” is understood to follow unless explicitly stated otherwise.

As used herein, the terms “data,” “content,” “information,” and similar terms may be used interchangeably to refer to data capable of being transmitted, received and/or stored in accordance with embodiments of the present invention.

Embodiments of the present disclosure provide methods and systems for identifying low visibility or obstructed conditions with respect to sensing devices (e.g., optical devices, cameras) that may be part of various systems (e.g., robotic, vehicle, cooperative systems, and/or combinations thereof). In some examples, image data is monitored and analyzed to detect conditions which may lead to triggering various corrective operations, including transmitting indications of detected low visibility or obstructed condition(s) to other apparatuses. The low visibility or obstructed condition can include sun glare, unwanted object(s) in a field of view, or combinations thereof.

### Example System

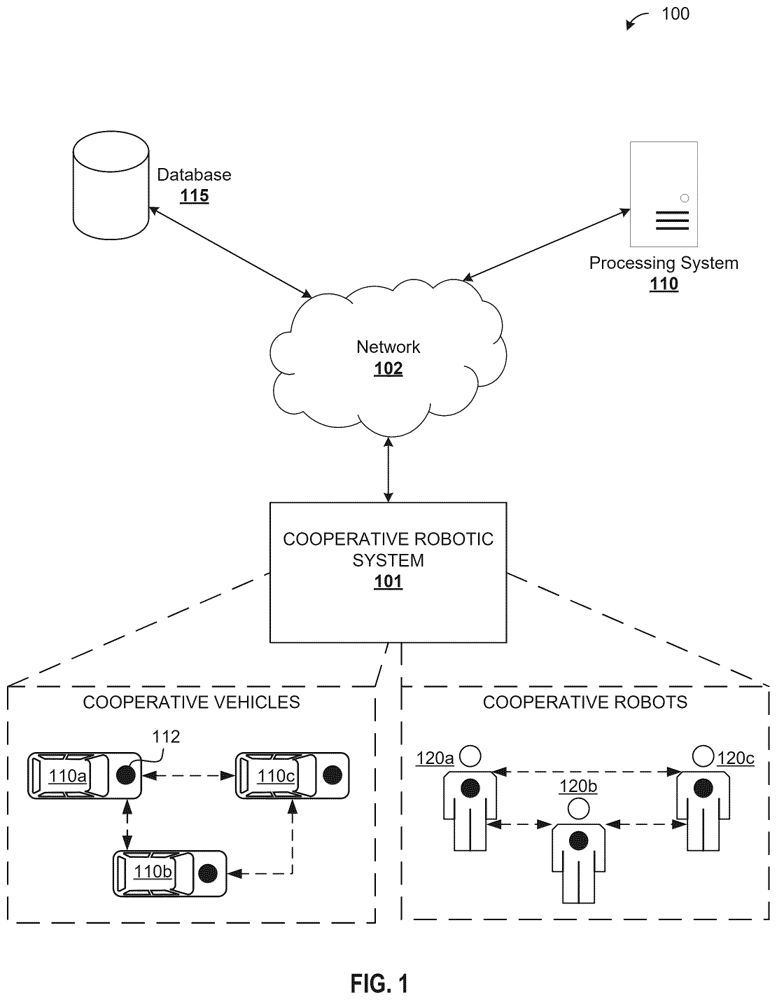

FIG. 1 is an example system 100 in accordance with certain embodiments of the present disclosure. As shown in FIG. 1, the system 100 includes a processing system 110 configured to communicate with a cooperative robotic system 101. In various implementations, the processing system 110 and the cooperative robotic system 101 are configured to transmit data to and receive data from one another over a network 102. The system 100 can include one or more databases, data stores, repositories, and the like. As shown, the system 100 includes database(s) 115 in communication with the cooperative robotic system 101 and the processing system 110. In some implementations, the database(s) 115 can be hosted by the processing system 110.

In some implementations, as illustrated, the cooperative robotic system 101 can be embodied as a cooperative driving system comprising a plurality of cooperative vehicles 110a, 110b, 110c (e.g., autonomous vehicles, semi-autonomous vehicles, or combinations thereof) in electronic communication with one another. For example, the cooperative robotic system can comprise a plurality of autonomous vehicles each using machine vision operations/techniques to navigate its environment. In other implementations, the cooperative robotic system 101 is embodied as a plurality of cooperative robots 120a, 120b, and 120c (e.g., surgical robots, care-giving robots, autonomous drones, autonomous military vehicles, and/or the like) in electronic communication with one another. Each of the plurality of cooperative vehicles 110a, 110b, 110c or plurality of cooperative robots 120a, 120b, and 120c can comprise one or more sensing devices configured to monitor and/or obtain real-time information/data from the environment (e.g., image data, video data, audio data, vehicle data, body data from one or more individuals, environmental data (e.g., temperature, pressure) and the like). For example, as shown, the first cooperative vehicle 110a comprises at least one sensing device 112. In some examples, the sensing devices can be or comprise optical devices, advanced cameras and/or sensors that may utilize high dynamic range (HDR) imaging and adaptive exposure control to improve visibility in bright conditions. Additionally, example sensing devices can also include infrared cameras, LiDAR, RADAR, or combinations thereof.

By way of example, each of the plurality of cooperative vehicles 110a, 110b, 110c or plurality of cooperative robots 120a, 120b, 120c can be configured to identify low visibility or obstructed conditions and transmit indications of the detected conditions to one or more other vehicles or robots that are within a predetermined range. These indications can be used to trigger corrective operations in relation to the other vehicles or robots. In some implementations, a given vehicle or robot can transmit such information to a server (e.g., processing system 110) where it may be stored in a database 115 for subsequent analysis and/or used to generate and send indications to vehicles or robots in communication therewith or in response to requests for such information.

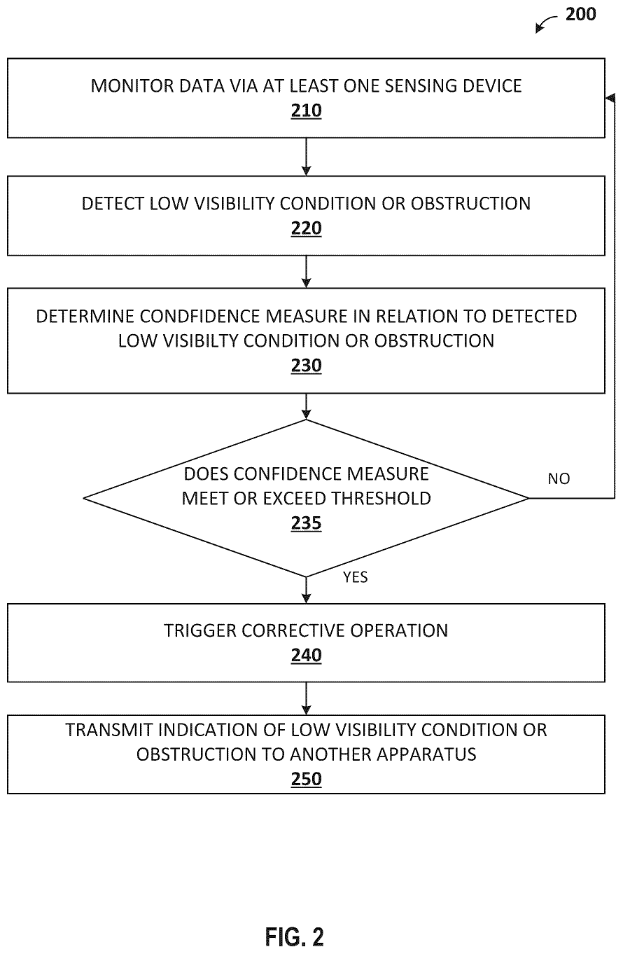

Referring now to FIG. 2, a flowchart diagram depicting a method 200 for identifying and correcting low visibility or obstructed conditions is shown. This disclosure contemplates that the example method 200 can be performed using one or more computing devices (e.g., at least the configuration illustrated in FIG. 4 by box 402).

At step/operation 210, the method 200 includes monitoring data (e.g., an environment, such as a vehicle's environment or an autonomous robot's environment), such as, but not limited to, image data/video data) via at least one sensing device above. As described above, the at least one sensing device may be operatively coupled to or a component of a cooperative robotic system such as an autonomous vehicle or autonomous robot. The at least one sensing device can be or comprise one or more optical devices, image sensors, location sensors (such as a global positioning system (GPS) sensor), camera(s), two dimensional (2D) and/or three dimensional (3D) light detection and ranging (LiDAR) sensor(s), long, medium, and/or short range radio detection and ranging (RADAR) sensor(s), ultrasonic sensors, electromagnetic sensors, (near-) infrared (IR) cameras, 3D cameras, 3600 cameras, accelerometer(s), gyroscope(s), and/or other sensors that enable the vehicle or robot to determine one or more features of the corresponding surroundings, and/or other components configured to perform various operations, procedures, functions or the like described herein.

At step/operation 220, the method 200 includes detecting a low visibility or obstructed condition based, at least in part, on the monitored data. In some examples, the method 200 includes determining the low visibility or obstructed condition based, at least in part, on direct analysis of image data (e.g., identifying one or more images that are washed out due to excessive light). Direct analysis of the image data can include periodically sampling one or more frames of the monitored image data. Additionally, and/or alternatively, the method 200 includes determining the low visibility or obstructed condition based, at least in part, on a measure of brightness or contrast (e.g., glare, sun glare, blur, obstruction) with respect to one or more frames of the image data that meets or exceeds a predetermined threshold.

In some implementations, the method 200 includes determining the low visibility or obstructed condition based, at least in part, on real-time or historical visibility information/data corresponding with a geographic location of the at least one sensing device. The real-time or historical visibility information/data can include at least one of longitude, latitude, time of day, direction, and current weather conditions. For example, such information can be used to determine a predictive output that is indicative of a likelihood that the system (e.g., vehicle, robot) is in a geographic location or position where it will experience a low visibility or obstructed condition. The example predictive output can be based on a direction of travel, time of day, or weather conditions.

In some implementations, the method 200 includes determining the low visibility or obstructed condition and/or an appropriate corrective operation using a machine learning model, such as a trained neural network model or object-permanence model. For example, the method 200 can include identifying the low visibility or obstructed condition based on a detected deviation from an object-permanence model. An object-permanence model can be a model in which an object is understood to continue to exist when it is out of sight.

Optionally, at step/operation 230, the method 200 includes determining a confidence measure in relation to the detected low visibility or obstructed condition. In some implementations, the method 200 includes determining the confidence measure based at least in part on data (e.g., vehicle data) obtained from one or more other apparatuses or computing devices (e.g., vehicles, robots, databases, or the like). Accordingly data from other sources (e.g., databases, vehicles, or robots) can be used to confirm or validate whether or not a low visibility or obstructed condition is present.

At step/operation 235, the method 200 includes determining whether the determined confidence measure meets or exceeds a predetermined threshold value. By way of example, the method 200 can include determining whether a predetermined/threshold number of images or frames obtained within a time period are washed out due to excessive light. An example threshold can be 12 frames out of a total of 30 frames within a time period of 1 second. Accordingly if the processor or computing device determines that 14 frames out of 30 frames obtained within 1 second are washed out due to excessive light, then the processor determines that the confidence measure has been met or exceeded. Additionally, and/or alternatively, the computing device can obtain additional data (e.g., from one or more databases, one or more other computing devices, such as AVs within the area) if a clear determination cannot be made, such as if the confidence measure is close to or within a certain range of the predetermined threshold value (e.g., 12 or 13 frames in the above example). In some examples, the computing device obtains real-time or historical visibility information/data corresponding with a geographic location of the at least one sensing device. Such information can be used to validate or confirm whether there is a low visibility condition or obstruction. Advantageously, additional data and further processing can be performed only when necessary for making a determination, thereby conserving computational resources. If the determined confidence measure does not meet the predetermined threshold, then the method 200 returns to step/operation 210.

At step/operation 240, the method 200 includes triggering a corrective operation in an instance in which the determined confidence measure satisfies, meets, or exceeds a predetermined threshold value. For example, in response to the detected and/or validated low visibility or obstructed condition. A corrective operation can include changing a position or angle of incidence of the at least one sensing device. In some implementations, the corrective operation can include adjusting one or more image processing parameters of image processing software utilized by the system/processor, modifying an operational parameter of the at least one sensing device (e.g., lens position or orientation), and/or applying a polarizing filter.

At step/operation 250, the method 200 includes transmitting an indication of the low visibility or obstructed condition to another apparatus (e.g., another self-driving car) that is within a predetermined range of the at least one sensing device or to a central server.

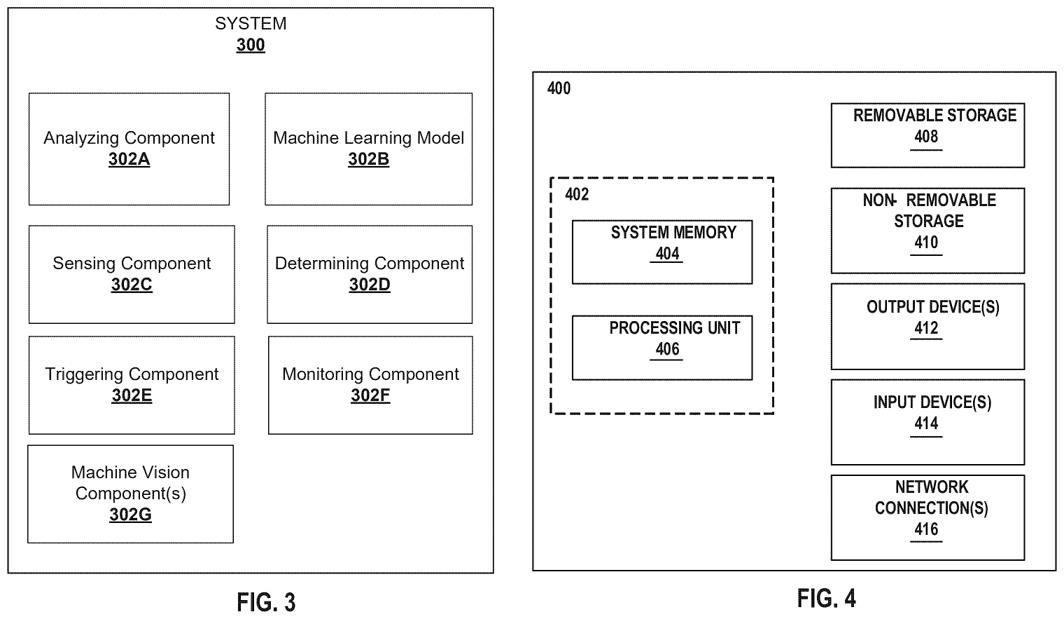

Referring now to FIG. 3, an example system 300 is shown. The system 300 can be configured to perform the method 200 described above in connection with FIG. 2. In various implementations, the system 300 is embodied as a vehicle, robot, computing device, or remote server. For example, the system 300 may be located remotely from a vehicle, while in other embodiments, the system 300 and the vehicle may be collocated, such as within the vehicle. Each of the components of the system, may be in communication with one another over the same or different wireless or wired networks including, for example, a wired or wireless Personal Area Network (PAN), Local Area Network (LAN), Metropolitan Area Network (MAN), Wide Area Network (WAN), cellular network, and/or the like. In some embodiments, a network may comprise the automotive cloud, digital transportation infrastructure (DTI), radio data system (RDS)/high-definition radio (HD) or other digital radio system, and/or the like. For example, a vehicle may be in communication with the system 300 via the network and/or via the Cloud. In the example shown in FIG. 3, the system 300 includes analyzing component(s) 302A, machine learning model(s) 302B, sensing component(s) 302C, determining component(s) 302D, triggering component(s) 302E, monitoring component(s) 302F, and machine vision component(s) 302G.

### Example Sensing Device

As detailed herein, an example vehicle or robot can include one or more sensing devices that in turn comprise camera(s), sensor(s), and the like.

Advanced cameras and sensors: Autonomous vehicles are increasingly being equipped with high-resolution cameras and sensors that can better handle sun glare. These cameras and sensors use a variety of techniques, such as high dynamic range (HDR) imaging and adaptive exposure control, to improve visibility in bright conditions.

Infrared cameras: Infrared cameras can detect heat radiation, which can be used to see through sun glare. This technology is still in development, but it has the potential to significantly improve the performance of autonomous vehicles in bright conditions.

LiDAR: LiDAR is a laser-based technology that can create a 3D map of the surrounding environment. This map can be used to identify objects and road markings, even in conditions where cameras are impaired by sun glare.

RADAR: RADAR is a radio-based technology that can detect objects by measuring the reflection of radio waves. RADAR can be used to identify objects and road markings, even in conditions where cameras and LiDAR are impaired by sun glare.

### Machine Learning

In addition to the machine learning operation described above, the exemplary system can be implemented using one or more artificial intelligence and machine learning operations. The term “artificial intelligence” can include any technique that enables one or more computing devices or comping systems (i.e., a machine) to mimic human intelligence. Artificial intelligence (AI) includes but is not limited to knowledge bases, machine learning, and deep learning. The term “machine learning” is defined herein to be a subset of AI that enables a machine to acquire knowledge by extracting patterns from raw data. Machine learning techniques include, but are not limited to, transformer-based models (e.g., Bidirectional Encoder Representations from Transformers (BERT), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target) during training with a labeled data set (or dataset). In an unsupervised learning model, the algorithm discovers patterns among data. In a semi-supervised model, the model learns a function that maps an input (also known as feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similar to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### Computing Devices and Methods of Use

It should be appreciated that the logical operations described herein with respect to the various figures may be implemented (1) as a sequence of computer-implemented acts or program modules (i.e., software) running on a computing device (e.g., the computing device described in FIG. 4), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special-purpose digital logic, and any combination thereof. It should also be appreciated that more or fewer operations may be performed than shown in the figures and described herein. These operations may also be performed in a different order than those described herein.

Referring to FIG. 4, an example computing device 400 upon which embodiments of the present disclosure may be implemented is illustrated. It should be understood that the example computing device 400 is only one example of a suitable computing environment upon which embodiments of the present disclosure may be implemented. Optionally, the computing device 400 can be a well-known computing system including, but not limited to, personal computers, servers, handheld or laptop devices, multiprocessor systems, microprocessor-based systems, personal network computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, the computing device 400 typically includes at least one processing unit 406 and system memory 404. Depending on the exact configuration and type of computing device, system memory 404 may be volatile (such as random-access memory (RAM)), non-volatile (such as read-only memory (ROM), flash memory, etc.), or some combination of the two. This most basic configuration is illustrated in FIG. 4 by the dashed line 402. The processing unit 406 may be a standard programmable processor that performs arithmetic and logic operations necessary for the operation of the computing device 400. The computing device 400 may also include a bus or other communication mechanism for communicating information among various components of the computing device 400.

Computing device 400 may have additional features/functionality. For example, the computing device 400 may include additional storage such as removable storage 408 and non-removable storage 410 including, but not limited to magnetic or optical disks or tapes. Computing device 400 may also contain network connection(s) 416 that allow the device to communicate with other devices. Computing device 400 may also have input device(s) 414 such as a keyboard, mouse, touch screen, etc. Output device(s) 412, such as a display, speakers, printer, etc., may also be included. The additional devices may be connected to the bus in order to facilitate communication of data among the components of the computing device 400. All these devices are well-known in the art and need not be discussed at length here.

The processing unit 406 may be configured to execute program code encoded in tangible, computer-readable media. Tangible, computer-readable media refers to any media that is capable of providing data that causes the computing device 400 (i.e., a machine) to operate in a particular fashion. Various computer-readable media may be utilized to provide instructions to the processing unit 406 for execution. Example of tangible, computer-readable media may include but is not limited to, volatile media, non-volatile media, removable media and non-removable media implemented in any method or technology for storage of information such as computer-readable instructions, data structures, program modules or other data. System memory 404, removable storage 408, and non-removable storage 410 are all examples of tangible computer storage media. Examples of tangible, computer-readable recording media include but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 406 may execute program code stored in the system memory 404. For example, the bus may carry data to the system memory 404, from which the processing unit 406 receives and executes instructions. The data received by the system memory 404 may optionally be stored on the removable storage 408 or the non-removable storage 410 before or after execution by the processing unit 406.

It should be understood that the various techniques described herein may be implemented in connection with hardware or software or, where appropriate, with a combination thereof. Thus, the methods and apparatuses of the presently disclosed subject matter, or certain embodiments or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, for example, through the use of an application programming interface (API), reusable controls, or the like. Such programs may be implemented in a high-level procedural or object-oriented programming language to communicate with a computer system. However, the program(s) can be implemented in assembly or machine language if desired. In any case, the language may be a compiled or interpreted language, and it may be combined with hardware implementations.

In one embodiment, disclosed herein is a non-transitory computer-readable storage medium comprising instructions that, when executed, cause at least one processor to perform the method of any preceding embodiments.

Although certain implementations may refer to utilizing aspects of the presently disclosed subject matter in the context of one or more stand-alone computer systems, the subject matter is not so limited but rather may be implemented in connection with any computing environment. For example, the components described herein can be hardware and/or software components in a single or distributed systems, or in a virtual equivalent, such as, a cloud computing environment. Still further, aspects of the presently disclosed subject matter may be implemented in or across a plurality of processing chips or devices, and storage may similarly be affected across a plurality of devices. Such devices might include personal computers, network servers, and handheld devices, for example.

What is claimed is:

1. A system comprising:
at least one sensing device;
a processor in electronic communication with the at least one sensing device; and
a memory having instructions thereon, wherein the instructions when executed by the processor, cause the processor to:
monitor image data via the at least one sensing device; and
in response to detecting a low visibility or obstructed condition, trigger a corrective operation in relation to the at least one sensing device.

2. The system of claim 1, wherein the instructions when executed by the processor cause the processor to further:
determine a confidence measure in relation to the detected low visibility or obstructed condition; and
trigger the corrective operation in an instance in which the confidence measure satisfies a predetermined threshold.

3. The system of claim 2, wherein the confidence measure is determined based at least in part on data obtained from one or more other apparatuses or computing devices.

4. The system of claim 2, wherein triggering the corrective operation comprises changing a position or angle of incidence of the at least one sensing device.

5. The system of claim 1, wherein the instructions when executed by the processor cause the processor to further:
transmit an indication of the low visibility or obstructed condition to another apparatus or another self-driving car that is within a predetermined range of the at least one sensing device or to a central server.

6. The system of claim 1, wherein the low visibility or obstructed condition is determined based at least in part on at least one of: (a) direct analysis of the image data to identify one or more images that are washed out due to excessive light, (b) a predictive output based at least in part on a direction of travel, time of day, or weather condition, and (c) detected deviation from an object-permanence model.

7. The system of claim 6, wherein direct analysis of the image data comprises periodically sampling one or more frames of the image data.

8. The system of claim 6, wherein the low visibility or obstructed condition is detected based at least in part on a measure of brightness or contrast with respect to one or more frames of the image data that meets or exceeds a predetermined threshold.

9. The system of claim 1, wherein the low visibility or obstructed condition is determined based at least in part on real-time or historical visibility information/data corresponding with a geographic location of the at least one sensing device.

10. The system of claim 9, wherein the real-time or historical visibility information/data comprises at least one of longitude, latitude, time of day, direction, and weather conditions.

11. The system of claim 1, wherein triggering the corrective operation comprises at least one of: adjusting one or more image processing parameters of image processing software utilized by the system, modifying at least one operational parameter of the at least one sensing device, and applying a polarizing filter.

12. The system of claim 11, wherein the image data is utilized for machine vision operations.

13. The system of claim 1, wherein the instructions when executed by the processor cause the processor to further:
detect the low visibility or obstructed condition and/or determine an appropriate corrective operation based at least in part on the low visibility or obstructed condition using a neural network model that is configured to determine object permanence with respect to objects in the image data.

14. The system of claim 1, wherein the system is embodied as a fully autonomous vehicle, a semi-autonomous vehicle, surgical robot, or care-giving robot.

15. The system of claim 1, wherein the system comprises a machine vision system.

16. A cooperative driving or robotic system comprising:
a plurality of vehicles or robots in electronic communication with one another, each vehicle or robot comprising:
at least one sensing device;
a processor in electronic communication with the at least one sensing device; and
a memory having instructions thereon, wherein the instructions when executed by the processor, cause the processor to:
monitor image data via the at least one sensing device; and
in response to detecting a low visibility or obstructed condition, trigger a corrective operation in relation to the at least one sensing device,
wherein each of the plurality of vehicles or robots is configured to transmit an indication of detected low visibility or obstructed conditions to at least another vehicle and/or trigger corrective operations in relation to the at least another vehicle.

17. The cooperative driving or robotic system of claim 16, wherein each of the plurality of vehicles or robots is configured to transmit the indication of detected low visibility or obstructed conditions to at least another vehicle or robot and/or trigger corrective operations in relation to the at least another vehicle or robot when it is within a predetermined range.

18. The cooperative driving or robotic system of claim 16, wherein each vehicle is an autonomous or semi-autonomous vehicle.

19. A computer-implemented method for identifying and correcting low visibility or obstructed conditions, the computer-implemented method comprising:
monitoring image data via at least one sensing device;
in response to detecting a low visibility or obstructed condition, determine a confidence measure in relation to the detected low visibility or obstructed condition; and
triggering a corrective operation in relation to the at least one sensing device in an instance in which the determined confidence measure satisfies a predetermined threshold.

20. The computer-implemented method of claim 19, wherein triggering the corrective operation comprises changing a position or angle of incidence of the at least one sensing device.
